(19) United States
(12) Patent Application Publication
(10) Pub. No.: US 2024/0106604 A1
(43) Pub. Date: Mar. 28, 2024

(54) SYSTEMS AND METHODS FOR INDICATING ASSOCIATION BETWEEN PHASE TRACKING REFERENCE SIGNAL PORT AND DEMODULATION REFERENCE SIGNAL PORT

(71) Applicant: ZTE CORPORATION, Shenzhen (CN)

(72) Inventors: Meng MEI, Shenzhen (CN); Yang ZHANG, Shenzhen (CN); Chuangxin JIANG, Shenzhen (CN); Zhaohua LU, Shenzhen (CN); Bo GAO, Shenzhen (CN)

(73) Assignee: ZTE CORPORATION, Shenzhen (CN)

(21) Appl. No.: 18/521,869

(22) Filed: Nov. 28, 2023

Related U.S. Application Data
(63) Continuation of application No. PCT/CN2021/121146, filed on Sep. 28, 2021.

(51) Int. Cl. H04L 5/00

(52) U.S. Cl. CPC H04L 5/0051

(57) ABSTRACT

Presented are systems and methods for wireless communication. In one aspect, a wireless communication device receives from a wireless communication node, a first signaling that includes a PTRS-DMRS port association. The PTRS-DMRS port association may indicate or correspond to an association between a PTRS port and a DMRS port of the wireless communication device. In one aspect, the wireless communication device determines that the PTRS-DMRS port association corresponds to a first uplink transmission of a plurality of uplink transmissions.

### CROSS-REFERENCE TO RELATED APPLICATION

This application claims the benefit of priority under 35 U.S.C. § 120 as a continuation of PCT Patent Application No. PCT/CN2021/121146, filed on Sep. 28, 2021, the disclosure of which is incorporated herein by reference in its entirety.

### TECHNICAL FIELD

The disclosure relates generally to wireless communications, including but not limited to systems and methods for indicating or determining association between phase tracking reference signal (PTRS) port and demodulation reference signal (DMRS) port.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium for wireless communication between a wireless communication node and a wireless communication device. In some embodiments, the wireless communication node is a base station or a transmit receive point (TRP). In some embodiments, the wireless communication device is user equipment (UE).

In some embodiments, a wireless communication device receives from a wireless communication node, a first signaling that includes a PTRS-DMRS port association. The first signaling may be a downlink control information (DCI). The PTRS-DMRS port association may indicate or correspond to an association between a PTRS port and a DMRS port of the wireless communication device. In some embodiments, the wireless communication device determines that the PTRS-DMRS port association corresponds to a first uplink transmission of a plurality of uplink transmissions. In some embodiments, each of the plurality of uplink transmissions comprises a respective group physical uplink shared channel (PUSCH) transmission, a group of transmissions associated with a respective sounding reference signal (SRS) resource sets, a group of transmissions to a respective transmission-reception point (TRP), a group of transmissions associated with a respective quasi-colocation (QCL) assumption, or a group of transmissions associated with one path loss reference signal (PL-RS). In some embodiments, each group of transmissions includes at least one transmission. According to the determined PTRS-DMRS port association, the wireless communication device may execute, perform, or provide the first uplink transmission through a PTRS port and a DMRS port.

In some embodiments, the first uplink transmission is indicated with a larger number of actual PTRS ports, than others of the plurality of uplink transmissions. In some embodiments, the first uplink transmission is indicated with a smaller number of actual PTRS ports, than others of the plurality of uplink transmissions. In some embodiments, a maximum number of PTRS ports configured for the first uplink transmission is different from others of the plurality of uplink transmission. In some embodiments, the first uplink transmission is configured with a maximum number of PTRS ports, that is smaller than others of the plurality of uplink transmission. In some embodiments, the first uplink transmission has a rank of 2. In some embodiments, the first uplink transmission is configured with a maximum number of PTRS ports, that is larger than others of the plurality of uplink transmissions. A number of actual PTRS ports may be a number of unique or non-repeating PTRS ports for a set of DMRS ports or for a set of SRS ports. In some embodiments, the first signaling indicates a set of SRS ports. The wireless communication device may determine a number of actual PTRS ports associated with the set of SRS ports for the first uplink transmission. The wireless communication device may determine a number of actual PTRS ports associated with the set of SRS ports for a different uplink transmission of the plurality of uplink transmission. The wireless communication device may determine the first uplink transmission by comparing the numbers of actual PTRS ports for different uplink transmission of the plurality of uplink transmissions.

In some embodiments, the first uplink transmission is associated with at least one of: first transmit precoding matrix index (TPMI) field in the first signaling, first SRS resource indicator (SRI) field in the first signaling, a SRS resource set indicated in the first SRI field, a SRS resource set with a lower index (ID), or a SRS resource set associated with a transmission-reception point (TRP) having a higher priority.

In some embodiments, the PTRS-DMRS port association indicates, for a second uplink transmission of the plurality of uplink transmissions, that a PTRS port is associated with a DMRS port having a lower index than one or more other DMRS ports associated with the PTRS port. In some embodiments, the DMRS port is configured or indicated for the second uplink transmission and is not indicated in the PTRS-DMRS port association. For example, from a set of DMRS ports including a first DMRS port, a second DMRS port, a third DMRS port, and a fourth DMRS port, when the second DMRS port, the third DMRS port, and the fourth DMRS port are indicated or allocated as the first uplink transmission, and ii) the first DMRS port, the second DMRS port, and the third DMRS port are indicated or allocated as the second uplink transmission, if the wireless communication device determines, for the first uplink transmission according to the PTRS-DMRS port association, the third DMRS port, which is not indicated or assigned for the second uplink transmission, the wireless communication device may determine, from the first DMRS port, the second DMRS port, and the third DMRS port, the first DMRS port having a lower index for the second uplink transmission.

In some embodiments, the DMRS port is configured or indicated with a same index for the plurality of uplink transmissions. In some embodiments, the PTRS-DMRS port association indicates that a PTRS port is associated with a DMRS port that is configured or indicated with a same index for the plurality of uplink transmissions. For example, from a set of DMRS ports including a first DMRS port, a second DMRS port, a third DMRS port, and a fourth DMRS port, when i) the second DMRS port, the third DMRS port, and the fourth DMRS port are indicated or allocated as the first uplink transmission, and ii) the first DMRS port, the second DMRS port, and the third DMRS port are indicated or allocated as the second uplink transmission, the wireless communication device may determine, from the second DMRS port and the third DMRS port that are indicated or allocated for both the first uplink transmission and the second uplink transmission, the second DMRS port having a lower index for the first uplink transmission.

At least one aspect is directed to a system, method, apparatus, or a computer-readable medium for wireless communication. In some embodiments, a wireless communication node sends to a wireless communication device a first signaling that includes a PTRS-DMRS port association. The wireless communication node may transmit DCI that includes the first signaling. In some embodiments, the wireless communication node causes the wireless communication device to determine that the PTRS-DMRS port association corresponds to a first uplink transmission of a plurality of uplink transmissions. In some embodiments, examples of the plurality of uplink transmission include PUSCH transmissions, transmissions associated with different SRS resource sets, or transmissions to different TRPs.

The systems and methods presented herein include a novel approach for determining the PTRS-DMRS port association. In some embodiments, a wireless communication device receives a signaling of PTRS-DMRS port association, and applies/determines the PTRS-DMRS port association corresponding to a first uplink transmission of at least two uplink transmissions. In some embodiments, the first uplink transmission is indicated with more actual PTRS ports than other uplink transmissions. In some embodiments, the first uplink transmission is indicated with less actual PTRS ports than other uplink transmissions. In some embodiments, the first uplink transmission has a rank of two. In some embodiments, the first uplink transmission is associated with (e.g., determined/identified according to) at least one of: a first TPMI field, a first SRI field, a SRS resource set indicated in the first SRI field, a SRS resource set with a lower ID, or a SRS resource set is associated with a TRP having a higher priority. In some embodiments, the PTRS port is associated to the DMRS port with a lower index for other/remaining uplink transmission(s). In some embodiments, the PTRS-DMRS port association indicates that a DMRS port index is not configured or indicated for other/remaining uplink transmission(s).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example communication network with two TRPs and a wireless communication device, in accordance with some embodiments of the present disclosure;

FIGS. 4-7 illustrate example associations among PTRS ports, SRS ports, and DMRS ports, in accordance with some embodiments of the present disclosure; and

FIG. 8 illustrates a flow diagram of an example method for communicating according to PTRS-DMRS port association, in accordance with an embodiment of the present disclosure.

### DETAILED DESCRIPTION

### 1. Mobile Communication Technology and Environment

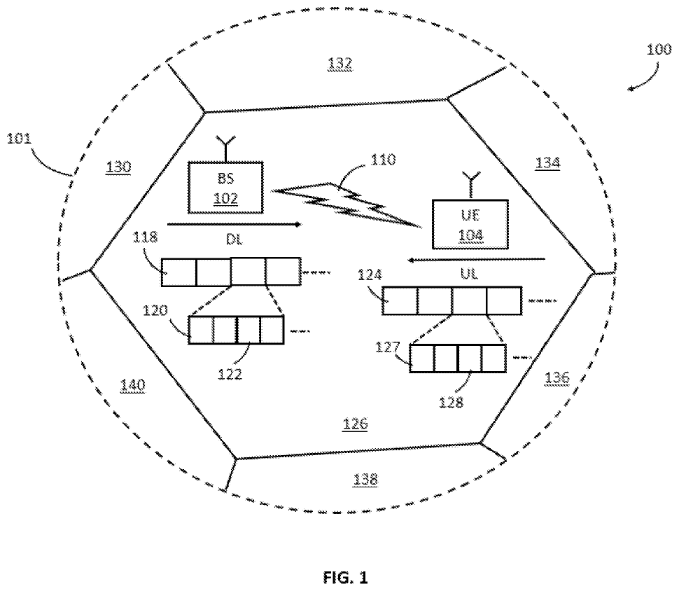

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

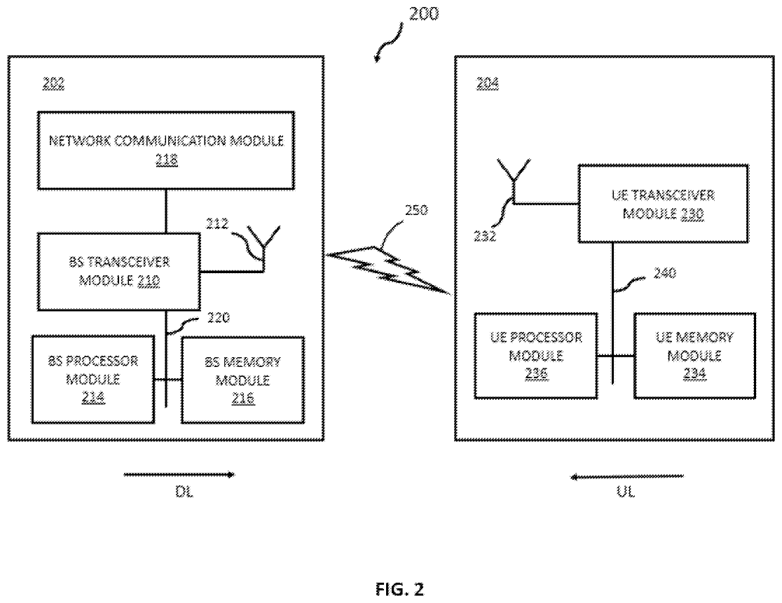

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication link 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 230 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 214 and 236, respectively, such that the processors modules 214 and 236 can read information from, and write information to, memory modules 216 and 234, respectively. The memory modules 216 and 234 may also be integrated into their respective processor modules 214 and 236. In some embodiments, the memory modules 216 and 234 may each include a cache memory for storing temporary variables or other intermediate information during execution of instructions to be executed by processor modules 214 and 236, respectively. Memory modules 216 and 234 may also each include non-volatile memory for storing instructions to be executed by the processor modules 214 and 236, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

2. Systems and Methods for Indicating and/or Determining PTRS-DMRS Port Association

In certain systems (e.g., 5G new radio (NR), Next Generation (NG) systems, 3GPP systems, and/or other systems), UE may communicate with multiple TRPs. For Multi-TRP (MTRP) PUSCH transmission, UE may transmit PUSCH to different TRPs. In one implementation, a single DCI may be used to indicate some configurations in the MTRP. Meanwhile, if PUSCH repetition is transmitted to different TRPs, one or more PTRS ports may be associated with unintended or different DMRS ports. A port herein refers to any resources (e.g., hardware, software, or a combination of them) for establishing or maintaining communication. For example, a PTRS port stores, assigns, allocates, indicates, or corresponds to resources for phase tracking for communication, according to PTRS. For example, a DMRS port stores, assigns, allocates, indicates, or corresponds to resources for modulation (or demodulation) for communication, according to DMRS. In one aspect, incorrect or improper PTRS-DMRS port association of PUSCH may prevent or interfere with successful PUSCH transmission.

In some embodiments, a wireless communication device receives a signaling of PTRS-DMRS port association, and applies/determines the PTRS-DMRS port association corresponding to a first uplink transmission of at least two uplink transmissions. In some embodiments, the first uplink transmission is indicated/configured (e.g., via DCI signaling) with more actual PTRS ports than other uplink transmissions. In some embodiments, the first uplink transmission is indicated with less actual PTRS ports than other uplink transmissions. In some embodiments, the first uplink transmission has a rank of two (e.g., the uplink transmission has two layers). In some embodiments, the first uplink transmission is associated with at least one of: a first TPMI field, a first SRI field, a SRS resource set indicated in the first SRI field, a SRS resource set with a lower ID, or a SRS resource set is associated with a TRP having a higher priority. In some embodiments, the PTRS port is associated with the DMRS port with a lower index (e.g., that is also indicated/configured) for other/remaining uplink transmission(s). In some embodiments, the PTRS-DMRS port association indicates/specifies (or includes information from which it is inferred) that a DMRS port index is not configured or indicated for other/remaining uplink transmission(s).

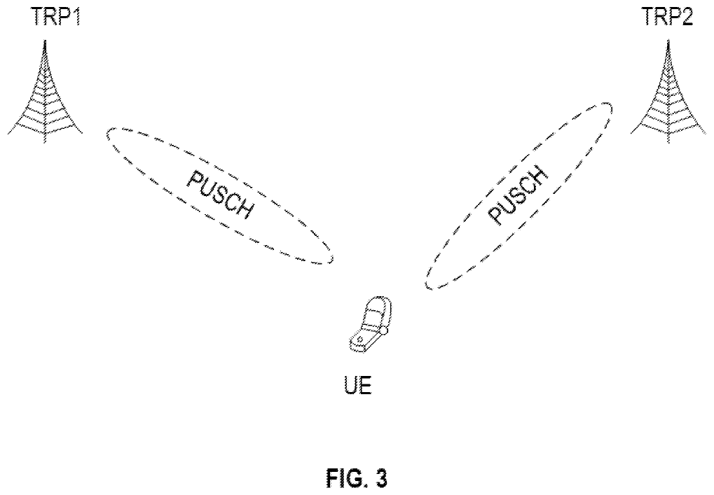

Referring now to FIG. 3, depicted is an example communication network with two TRPs and a UE, in accordance with some embodiments of the present disclosure. The UE may be the UE 104 of FIG. 1, and the TRP1, TRP2 may be part of or operate as the BS 102 of FIG. 1. In some embodiments, the example communication network may include additional TRPs and UEs than shown in FIG. 3.

In the uplink transmission, one SRS resource set may be configured for one group of PUSCH transmission (and/or one TRP). Each group of transmission may include at least one PUSCH transmission, and each group may be associated with one SRS resource set, one quasi-colocation (QCL) assumption, or path loss reference signal (PL-RS). The SRI and TPMI for codebook based transmission and SRI for non-codebook based transmission in DCI may be indicated, transmitted, notified, and/or provided to the UE as the SRS resource or the precoder for uplink transmission. When there are two or more TRPs (e.g., TRP1, TRP2) as shown in FIG. 1, same PUSCH may be transmitted to the two or more TRPs. For a PUSCH transmission, the association of PTRS port and the DMRS port may be indicated by a DCI signaling. For example, the TPMI in DCIs may include or indicate the rank (number of layers) and the SRS resource for each layer. In some cases, one PTRS port is supported for the coherent uplink transmission and for non-coherent and partial coherent uplink transmission. For example, the SRS port 0 and port 2 may share PTRS port 0, and SRS port 1 and port 3 may share PTRS port 1. If the TPMI is indicated to one UE, the UE may determine or identify the uplink transmission layer and a SRS port for each layer. However, two or more DMRS ports may share one PTRS port, as a corresponding SRS port is used for each of the DMRS ports.

In the single DCI based MTRP PUSCH transmission, two SRI fields and TPMI fields may be included or indicated in the DCI field, so that the association between PTRS and DMRS may be different for different PUSCH transmission groups (transmitted to different TRPs). As such, the association between PTRS and DMRS port should be indicated/specified for different PUSCH transmission groups associated with different SRS resource set respectively. Without correct or proper PTRS-DMRS port associations, UE may not successfully perform, complete, and/or execute PUSCH transmission(s) to MTRP.

For non-codebook based UL transmission, the actual number of UL PT-RS port(s) to transmit may be determined based on SRI(s) in DCI or higher layer parameter. The UE may be configured with the PTRS (or PTRS) port index for each configured SRS resource by the higher layer parameter. If the PT-RS port index associated with different SRIs are the same, the corresponding UL DMRS (or DM-RS) ports may be associated with the one or same UL PT-RS port. In a DCI field, two bits may indicate the PTRS-DMRS port association for one UL transmission. Without correct or proper PTRS-DMRS port associations, UE may not successfully perform, complete, and/or execute PUSCH transmission to MTRP.

### A. First Example Implementation of PTRS-DMRS Port Association Indication/Determination

In some embodiments, the indication and/or determination of the PTRS-DMRS port association is based on SRI indicating a number of actual PTRS ports. A number of actual PTRS ports may be a number of unique or non-repeating PTRS ports for a set of DMRS ports or for a set of SRS ports (indicated, activated or configured in a SRS resource set), for instance determined from all possible PTRS ports available (to the SRS resource set). In one aspect, a SRS port stores, assigns, allocates, indicates, or corresponds to resources for performing sounding (using SRS).

For MTRP uplink transmission, when two or more SRS resource sets are configured independently, each SRS resource set may be configured with one or more SRS resources or ports, and the SRS resources or ports may be different for different SRS resource sets. In one aspect, more SRS resource sets configured for PUSCH repetition transmission may cause more SRS resources configured or indicated to be the same or different for different SRS resource sets, because the SRS resources may configured or indicated independently for different SRS resource set. For non-codebook based uplink transmission, if two SRS resource sets are configured or determined, the SRS resources, SRS resource sets, SRS ports, or any combination of them may be configured or determined by radio resource control (RRC), and the associated PTRS port associated with one SRS resource may be also configured or determined by RRC signaling/configuration. For PUSCH transmission, the SRS resource or port may be indicated in the SRI field in DCI. Considering that one SRS resource or port may be associated with one DMRS port, the DMRS port may be also associated with the configured PTRS port. In the case that different DMRS ports share one PTRS port, the PTRS-DMRS port associations may be indicated in DCI, for example, to indicate which one of the DMRS ports is associated with the PTRS port.

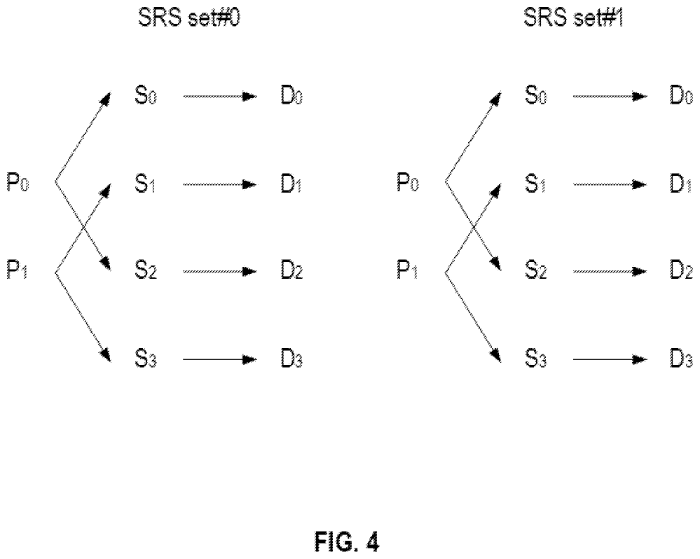

FIG. 4 illustrates example associations among PTRS ports, SRS ports, and DMRS ports, in accordance with some embodiments of the present disclosure. In the example shown in FIG. 4, four SRS resources or ports S0-S3 are configured and two PTRS ports P0, P1 are configured for both SRS resource sets #0, #1. Specifically, in the example in FIG. 4, the SRS set #0 includes or indicates PTRS port P0 associated with SRS ports S0, S2, and PTRS port P1 associated with SRS ports S1, S3, where each of the SRS ports S0-S3 is associated with a corresponding one of the DMRS ports D0-D3, respectively. In addition, in the example in FIG. 4, the SRS set #1 includes or indicates PTRS port P0 associated with SRS ports S0, S2, and PTRS port P1 associated with SRS ports S1, S3, where each of the SRS ports S0-S3 is associated with a corresponding one of the DMRS ports D0-D3, respectively. In one configuration, the SRS set #0 may be associated with one uplink transmission (e.g., PUSCH) to one of the TRP1 and TRP2, and the SRS set #1 may be associated with another uplink transmission (e.g., PUSCH) to the other of the TRP1 and TRP2.

In some embodiments, SRI in the DCI field may indicate the SRS resources or ports for uplink transmission, so the actual SRS resources or ports number or the PTRS ports number may be different. For example, if the SRS resource sets #0 and #1 are indicated (e.g., via DCI or MAC CE signaling) with different SRS resources or ports (e.g. SRS ports S0 and S1 are configured for SRS resource set #0, and SRS ports S0 and S2 are configured for SRS resource set #1), then the actual number of PTRS ports may be two (P0, P1) for SRS resource set #0 and the actual number of PTRS ports may be one (P0) for SRS resource set #1. Thus, the PTRS-DMRS port association may be associated with or indicated by the first SRI field, which indicates more actual (number of) PTRS ports. That is, SRI field can also indicate that the PTRS-DMRS port association field is associated with which SRI field.

In some embodiments, the uplink transmission is indicated with a larger number of actual PTRS ports, than others of the plurality of uplink transmissions. For example, the two bits in the PTRS-DMRS port association can be used to indicate the PTRS and DMRS port association of the SRS resource set with more actual PTRS ports. If the SRS ports S0 and S1 are indicated in the first SRI field associated with the first SRS resource set #0, the PTRS-DMRS port association can be indicated as ‘00’ according to the indicated SRS resource or port of SRS resource set #0. Meanwhile, the PTRS-DMRS port association can also be used for SRS resource set #1. If S0 and S2 share one PTRS port P0, whether the PTRS port is associated with D0 or D1 may be also indicated by this PTRS-DMRS port association field, and ‘00’ may indicate that the PTRS port is associated with DMRS port D0. In some embodiments, the uplink transmission is indicated with a smaller number of actual PTRS ports, than others of the plurality of uplink transmissions. For example, the PTRS-DMRS port association indication may be associated with the SRI which indicates a fewer number of actual PTRS ports, instead of more/higher number of actual PTRS ports.

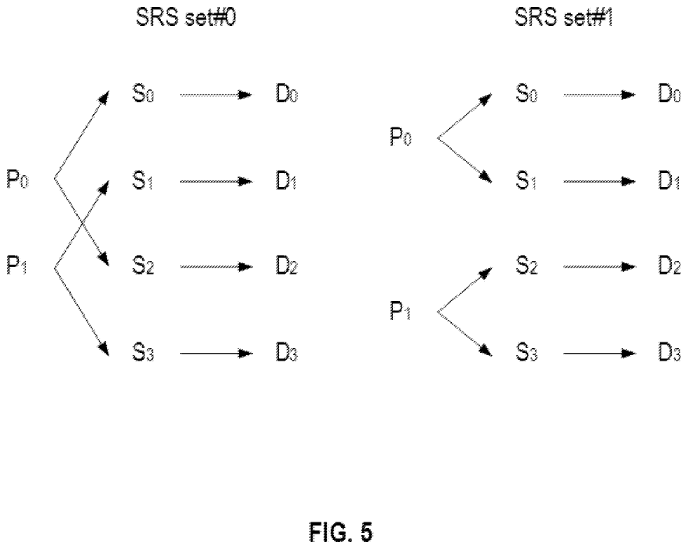

FIG. 5 illustrates example associations among PTRS ports, SRS ports, and DMRS ports, in accordance with some embodiments of the present disclosure. In the example shown in FIG. 5, four SRS resources or ports S0-S3 are configured and two PTRS ports P0, P1 are configured for both SRS resource sets #0, #1. Specifically, in the example in FIG. 5, the SRS set #0 includes or indicates PTRS port P0 associated with SRS ports S0, S2, and PTRS port P1 associated with SRS ports S1, S3, where each of the SRS ports S0-S3 is associated with a corresponding one of the DMRS ports D0-D3, respectively. In addition, in the example in FIG. 5, the SRS set #1 includes or indicates PTRS port P0 associated with SRS ports S0, S1, and PTRS port P1 associated with SRS ports S2, S3, where each of the SRS ports S0-S3 is associated with a corresponding one of the DMRS ports D0-D3, respectively.

In the example shown in FIG. 5, if two SRS resources or ports are indicated for each SRS resource set, (e.g., the SRS ports S1 and S0 are indicated for the SRS resource set #0, the SRS ports S0 and S2 are indicated for the SRS resource set #1), then two PTRS ports may be indicated for the SRS resource set #0 and two PTRS ports may be indicated for the SRS resource set #1. Hence, the SRS resources sets #0, #1 may have the same actual number of PTRS ports.

In some embodiments, in case the SRS sets #0, #1 have the same actual number of PTRS ports, a DMRS port can be determined according to one or more rules. For example, the DMRS port with a priority may be selected or determined. For example, if the association indicates that the PTRS is associated with one DMRS port associated with one SRS resource set, but the association indicates one DMRS port that is not configured or indicated for the other SRS resource set, the PTRS may be associated with the DMRS port with a lower ID (e.g., identified from configured/indicated DMRS ports) of the transmission associated with the other SRS resource set.

Similar principles can be applied to different number or different ranks of uplink transmissions. For example, for rank 3 uplink transmission, three SRS resources or ports may be indicated for each SRS resource set, and two PTRS ports may be indicated for each SRS resource set. In one example, two SRS ports may share one PTRS port, and the other SRS port may be associated with one PTRS port, and one SRS port may be associated with one DMRS port for non codebook based transmission. Hence, only one bit may be employed for the indication of DMRS ports that shares one PTRS port. In one approach, the two bits in the DCI field can be split to two independent bits, and each bit may be used to indicate which of the two DMRS ports that share one PTRS port is associated with the PTRS port for each SRS resource set indicated by one SRI. In one approach, the PTRS-DMRS port association field may be associated with one SRI by default. In some embodiments, the default SRI is associated with the SRS resource set of lower ID. In some embodiments the default SRI is indicated in the first SRI field. In some embodiments, the default SRS resource set may be indicated in the first SRI field. In some embodiments, the default SRS resource set may be the SRS resource set with a lower ID. In some embodiments, the default SRS resource set is associated with the TRP having a higher priority.

In some embodiments, the PTRS-DMRS port association indicates, for an uplink transmission, that a PTRS port is associated with a DMRS port having a lower index than one or more other DMRS ports associated with the PTRS port. In some embodiments, at least one DMRS port is configured or indicated for the second uplink transmission and is not indicated in the PTRS-DMRS port association. Assuming for an example that, for rank 4 uplink transmissions, three DMRS ports share one PTRS port for both of the two PUSCH transmissions, and DMRS port is indicated as ports 1, 2, 3 for the first PUSCH transmission; DMRS port is indicated as ports 0, 1, 2 for the second PUSCH transmission; and the PTRS-DMRS port association indicates that the PTRS port is associated with DMRS port 3 (for first PUSCH). Further assuming for an example that for the second PUSCH transmission, DMRS port 3 is not indicated in either set (1, 2, 3) or (0, 1, 2). In this example, the PTRS port may be associated with the DMRS port with the lower index configured or indicated for the second PUSCH, (e.g., DMRS port 0, which has a lower index than ports 1, 2).

In some embodiments, at least one DMRS port is configured or indicated with a same index for the plurality of uplink transmissions. In some embodiments, the PTRS-DMRS port association indicates that a PTRS port is associated with a DMRS port that is configured or indicated with a same index for the plurality of uplink transmissions. For example, the PTRS port may be associated with the DMRS port with a lower index that has the same index as that of the first PUSCH (e.g., DMRS port 1, which is included in both sets (1, 2, 3) and (0, 1, 2), and has the lowest index from the ports 1, 2).

In some embodiments, for the indication of PTRS-DMRS port association for multiple PUSCH transmissions, the indication can be determined for a DMRS port with the same index for the PUSCH transmissions associated with different SRS resource sets. Assuming for an example that the DMRS ports 1, 2, 3 are indicated for the first PUSCH transmission associated with the first SRS resource set, and DMRS ports 0, 1, 2 are indicated for the second PUSCH transmission associated with the second SRS resource set. In this example, DMRS port 1, 2 may be indicated or configured with the same index for all/both the PUSCH transmissions, and therefore the PTRS port may be associated with DMRS port 1 or 2. For one PTRS port, ‘01’ in the PTRS-DMRS port association field can be used to indicate that the PTRS port is associated with DMRS port 1, and ‘10’ in the PTRS-DMRS port association field can be used to indicate that the PTRS port is associated with DMRS port 2.

### B. Second Example Implementation of PTRS-DMRS Port Association Indication/Determination

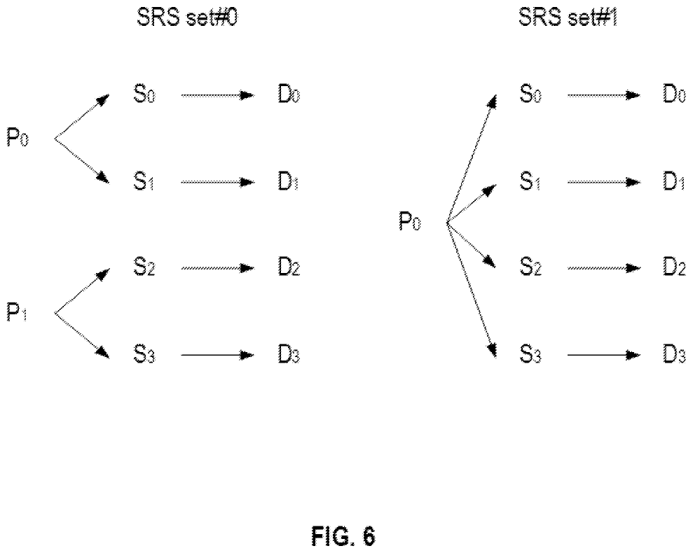

FIG. 6 illustrates example associations among PTRS ports, SRS ports, and DMRS ports, in accordance with some embodiments of the present disclosure. In the example shown in FIG. 6, four SRS resources or ports S0-S3 are configured and two PTRS ports P0, P1 are configured for both SRS resource sets #0, #1. Specifically, in the example in FIG. 6, the SRS set #0 includes or indicates PTRS port P0 associated with SRS ports S0, S1 and PTRS port P1 associated with SRS ports S2, S3, where each of the SRS ports S0-S3 is associated with a corresponding one of the DMRS ports D0-D3, respectively. In addition, in the example in FIG. 6, the SRS set #1 includes or indicates PTRS port P0 associated with SRS ports S0-S3, where each of the SRS ports S0-S3 is associated with a corresponding one of the DMRS ports D0-D3, respectively.

In the example shown in FIG. 6, different numbers of PTRS ports are configured for the SRS sets #0, #1, where SRS resource set #0 is configured with a maximum number of PTRS ports of 2, and the SRS resource set #1 is configured with a maximum number of PTRS ports of 1. Specifically, for SRS resource set #0, P0 and P1 are each shared with up to two SRS resources or ports or DMRS ports, respectively. The maximum number of PTRS port may be configured as one for SRS resource set #1, and the PTRS port P0 may be associated with up to 4 SRS resources or ports S0-S3 or DMRS ports D0-D3. In some embodiments, for the indication of the PTRS-DMRS port association, the two bits for SRS resource set 0 may be used to indicate the PTRS port and DMRS port association for each PTRS port respectively. In some embodiments, the two bits for SRS resource set #1 may be used to indicate that the PTRS port is associated with which DMRS port of the four DMRS ports.

Because one PTRS-DMRS field can be indicated in the DCI, two bits can be used for the indication. Thus, the SRI may indicate the actual SRS resources or ports, and also the actual PTRS port with the configuration of PTRS ports and the SRS resource or ports. Assuming for an example that the SRS resource or port is indicated as S0 and S1 for the SRS resource set #0 and set #1, respectively in FIG. 6, the PTRS-DMRS port association may be associated with the first SRI field that indicated the SRS resource or port for SRS resource set #0, and ‘01’ can indicate the PTRS port is associated with DMRS port D1, and this indication can be used to indicate that the PTRS port is associated with the DMRS port D0 for SRS resource set #1. If different numbers of SRS resources or ports are configured for different SRS resource sets, the PTRS-DMRS port association may be also indicated based on the indication of the SRI with more actual PTRS ports.

Also considering the actual PTRS port number can be different between the two SRS resource sets, one example scenario may be such that SRS resource set #0 is configured with 2 PTRS ports, and one PTRS is configured for SRS resource set #1. If two SRS ports are indicated for each SRS resource set, if two PTRS ports are indicated for SRS resource set #0, and each PTRS port is associated with one SRS port and DMRS port, there is no need to indicate the association of PTRS port and DMRS port, since each DMRS port corresponds to a respective PTRS port. But for SRS resource set #1, only one PTRS port is configured and indicated, which means that two DMRS ports share one PTRS port, so the association of PTRS port and DMRS port should be indicated to specify which DRMS port should correspond to the one PTRS port. In some embodiments, for rank 2 transmission, the PTRS-DMRS port association may be determined according to the SRI field that indicates less actual PTRS port number for one SRS resource set. In some embodiments, if the actual number of PTRS is the same for the two SRS resource sets, or the transmission rank is more than 2, the PTRS-DMRS port association field may be indicated according to one SRI or SRS resource set by one or more rules (e.g., based on priority or lower ID) as discussed above. In some embodiments, if the max number of PTRS is not the same for the two SRS resource sets, the PTRS-DMRS port association may indicate the association for the SRS resource set which is configured with more PTRS port number.

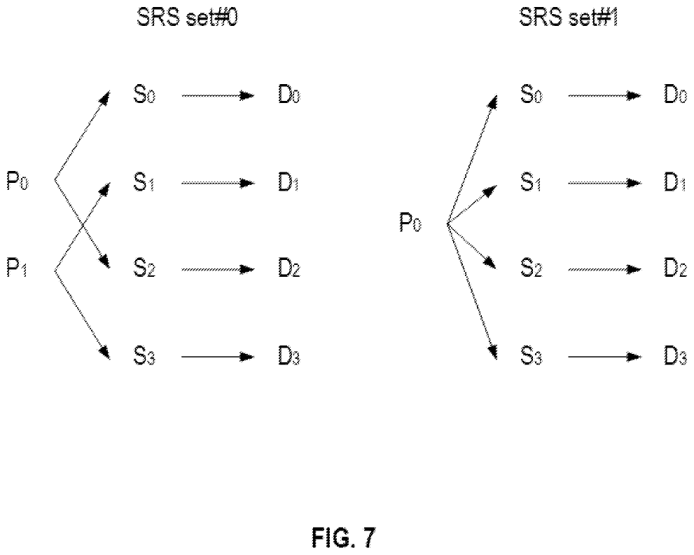

In the example shown in FIG. 7, different numbers of PTRS ports are configured for the SRS sets #0, #1, where SRS resource set #0 is configured with a maximum number of PTRS ports of 2, and the SRS resource set #1 is configured with a maximum number of PTRS ports of 1. Specifically, in the example in FIG. 7, the SRS set #0 includes or indicates PTRS port P0 associated with SRS ports S0, S2, and PTRS port P1 associated with SRS ports S1, S3, where each of the SRS ports S0-S3 is associated with a corresponding one of the DMRS ports D0-D3, respectively. In addition, in the example in FIG. 7, the SRS set #1 includes or indicates PTRS port P0 associated with SRS ports S0-S3, where each of the SRS ports S0-S3 is associated with a corresponding one of the DMRS ports D0-D3, respectively. As shown in FIG. 7, the SRS resource set #0 has a max number of PTRS ports of 2, and the SRS resource set #1 is configured a max number of PTRS port of 1. In some embodiments, if the maximum number of PTRS is not the same for the two SRS resource sets #0, #1, the PTRS-DMRS port association may indicate the association for the SRS resource set, which is configured with a lower maximum PTRS port number. For example, in the example in FIG. 7, because the SRS resource set #1 has a lower maximum number of PTRS ports than the SRS resource set #0, the PTRS-DMRS port association may indicate the association for SRS resource set #1.

### C. Third Example Implementation of PTRS-DMRS Port Association Indication/Determination

For codebook based transmission, at least one SRS resource may be configured for one SRS resource set, and one, two, or four SRS ports may be configured for one SRS resource. And the TPMI field can indicate the codebook for uplink transmission, so TPMI field can indicate the association of DMRS and SRS ports. For full coherent codebook, the number of PTRS port supported may be limited to one; and for partial and non coherent codebook, SRS ports 0 and 2 may share PTRS port 0, and SRS port 1 and port 3 may share PTRS port 1.

For coherent codebook, only one PTRS port may be configured or indicated, and for two, three, or four layer transmission, which DMRS port is associated with the PTRS port may be indicated in the DCI field. Considering for UL multi-TRP transmission, two SRI fields and TPMI fields may be indicated or included in the DCI field, so the PTRS-DMRS port association field can indicate which DMRS port is associated with the shared PTRS port according to one or more rules (e.g., based on priority or lower ID) described above.

For non coherent codebook transmission, the actual PTRS port number may be different for different SRS resource sets. For example, if the TPMI field indicated the layer with 2, and also indicated the codebook associated with SRS port 0 and SRS port 1 in the first TPMI field for the first SRI and SRS resource set, and the second TPMI field indicated the codebook associated with SRS port 0 and port 2, then the actual PTRS number may be 2 for SRS resource set 0, and is 1 for SRS resource set #1.

In one approach, the PTRS-DMRS port association field may be indicated according to the SRS resource set with more actual PTRS ports. For example, if ‘00’ is indicated, the two PTRS ports may be associated with SRS port 0 and 1 for SRS resource set #0, if the DMRS port 0 is associated with SRS port 0 and DMRS port 1 is associated with SRS port 1 according the indicated codebook, the PTRS ports are associated with the two DMRS ports respectively. For SRS resource set #1, the indication can also indicate that the one PTRS port is associated with DMRS port 0. If the codebook indicates the SRS ports 1 and 3 for SRS resource set #1, also one PTRS port may be associated with the two SRS ports. ‘00’ can indicate that the PTRS port is associated with the DMRS port with the lower ID which shares the same PTRS port.

In one approach, the PTRS-DMRS port association field may be indicated according to the SRS resource set with more actual (number of) PTRS ports. Also in the case of 2-layer transmission, for non codebook based transmission, and a maximum of two PTRS ports may be configured. If two PTRS ports are indicated for SRS resource set #0 and one PTRS port is indicated for SRS resource set #1, considering that the two PTRS ports are associated with the two DMRS ports according to the codebook, so there is no need to indicate the association of PTRS and DMRS ports for the SRS resource set 0, since there is a one-to-one correspondence/mapping between DRMS ports and PTRS ports.

Considering the case of more layers of transmission, no matter for non coherent or partial coherent or full coherent transmission, two or four DMRS ports that share one PTRS port may exist. In some embodiments, which of the DMRS ports is associated with the sharing PTRS port may be indicated according to one SRS resource set, SRI field, TPMI field by default, or any combination of them. The default rule may be to operate according to or as indicated by the first TPMI field. In one example, the default SRI is associated with the SRS resource set of lower ID. The default SRI may be the first SRI field. For example, the default SRS resource set may be indicated in the first SRI field. The default SRS resource set may be the SRS resource set with a lower ID. The default SRS resource set may be associated with the TRP having a higher priority.

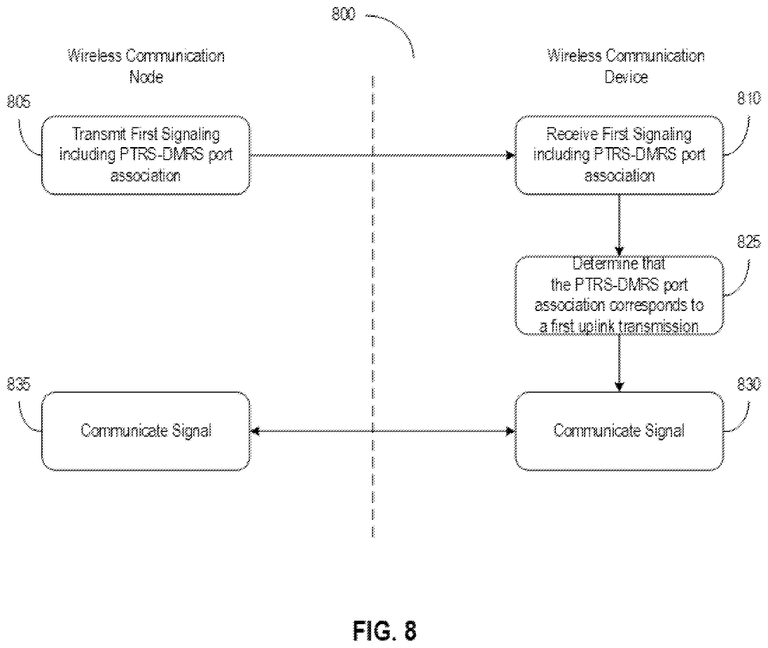

FIG. 8 illustrates a flow diagram of a method 800 for communication by determining PTRS-DMRS port association. The method 800 may be implemented using any of the components and devices detailed herein in conjunction with FIGS. 1-7. In brief overview, a wireless communication node may transmit signaling including a PTRS-DMRS port association (805). A wireless communication device may receive the signaling including the transmission parameter setting (810). The wireless communication device may determine that the PTRS-DMRS port association corresponds to a first uplink transmission (825). The wireless communication device may communicate a signal with the communication node (830 and 835).

In further detail, a wireless communication node (e.g., BS 102 and 202) may send, provide, or otherwise transmit a signaling (sometimes referred herein as a first signaling) including at least one transmission parameter setting to a wireless communication device (e.g., UE 104 and 204) (805). In some embodiments, the signaling includes, indicates, or corresponds to PTRS-DMRS port association. In some embodiments, the wireless communication node may also send additional signaling to the wireless communication device. The additional signaling may be transmitted to provide one or more transmission parameter settings to the wireless communication device to perform sensing information assisted beam management.

The wireless communication device may retrieve, identify, or otherwise receive the signaling including the transmission parameter setting from the wireless communication node (810). Upon receipt, the wireless communication device may parse the signaling to extract or identify PTRS-DMRS port association. According to the PTRS-DMRS port association, the wireless communication device may determine which PTRS-DMRS ports to utilize for communication (e.g., uplink transmission). The wireless communication device may control, configure, or select PTRS ports and DMRS ports for uplink transmissions to MTRP.

In some embodiments, the wireless communication device determines, identifies, or selects PTRS-DMRS port association or an uplink transmission by determining a number of actual PTRS ports (825). A number of actual PTRS ports may be a number of unique or non-repeating PTRS ports for a set of DMRS ports or for a set of SRS ports. In one approach, for different SRS resource sets, the wireless communication device may determine numbers of unique PTRS ports, for given SRS ports. The wireless communication device may determine, from a plurality of uplink transmission, an uplink transmission that corresponds to PTRS ports or DMRS ports from a SRS resource set with a higher actual PTRS ports (or a lower actual PTRS ports) than actual PTRS ports of another resource SRS set.

In some embodiments, the wireless communication device determines, identifies, or selects, PTRS-DMRS port association or an uplink transmission according to: a first TPMI field, a first SRI field, a SRS resource set indicated in the first SRI field, a SRS resource set with a lower ID, or a SRS resource set is associated with a TRP having a higher priority. In some embodiments, the wireless communication device determines PTRS-DMRS port association or an uplink transmission by determining DMRS port with a lower index for other uplink transmission. In some embodiments, the wireless communication device determines PTRS-DMRS port association or an uplink transmission by determining a DMRS port index not configured or indicated for other uplink transmission.

The wireless communication device may also retrieve, identify, receive, or determine the transmission parameter settings according to the additional signaling. In some embodiments, the wireless communication device may identify or determine the transmission parameter settings associated with the indicated beam state. The beam state may have been indicated in the additional signaling. In some embodiments, the wireless communication device may identify, select, or determine at least one transmission parameter setting from the plurality of transmission parameter settings. The at least one transmission parameter setting may be determined to be effective and to be applied to the signal for beam management. In some embodiments, the wireless communication device may identify or select the transmission parameter setting to use from the pool of transmission parameter settings.

The wireless communication device may communicate a signal with the communication node (830 and 835). For example, the wireless communication device may initiate, provide perform, or execute uplink transmission, according to PTRS-DMRS port association. Examples of the uplink transmission include a respective physical uplink shared channel (PUSCH) transmission, a transmission associated with a respective sounding reference signal (SRS) resource sets, or a transmission to a respective transmission-reception point (TRP).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a first signaling that includes a phase tracking reference signal (PTRS)-demodulation reference signal (DMRS) port association; and
determining, by the wireless communication device, that the PTRS-DMRS port association corresponds to a first uplink transmission of a plurality of uplink transmissions.

2. The method of claim 1,
wherein each of the plurality of uplink transmissions comprises a respective group of physical uplink shared channel (PUSCH) transmission, a group of transmissions associated with a respective sounding reference signal (SRS) resource sets, a group of transmissions to a respective transmission-reception point (TRP), a group of transmissions associated with a respective quasi-colocation (QCL) assumption, or a group of transmissions associated with one path loss reference signal (PL-RS), and
wherein each group of transmissions comprises at least one transmission.

3. The method of claim 1, wherein the first uplink transmission is indicated with a larger number of actual PTRS ports, than others of the plurality of uplink transmissions.

4. The method of claim 1, wherein the first uplink transmission is indicated with a smaller number of actual PTRS ports, than others of the plurality of uplink transmissions.

5. The method of claim 1, wherein the first uplink transmission has a rank of 2.

6. The method of claim 1, wherein the first uplink transmission is configured with a maximum number of PTRS ports, that is larger than others of the plurality of uplink transmissions.

7. The method of claim 1, wherein the first uplink transmission is associated with at least one of:
first transmit precoding matrix index (TPMI) field in the first signaling,
first SRS resource indicator (SRI) field in the first signaling,
a SRS resource set indicated in the first SRI field,
a SRS resource set with a lower index (ID), or
a SRS resource set associated with a transmission-reception point (TRP) having a higher priority.

8. The method of claim 1, wherein the PTRS-DMRS port association indicates, for a second uplink transmission of the plurality of uplink transmissions, that a PTRS port is associated with a DMRS port having a lower index than one or more other DMRS ports associated with the PTRS port.

9. The method of claim 8, wherein the DMRS port is configured or indicated for the second uplink transmission and is not indicated in the PTRS-DMRS port association, or
wherein the DMRS port is configured or indicated with a same index for the plurality of uplink transmissions.

10. The method of claim 1, wherein the PTRS-DMRS port association indicates that a PTRS port is associated with a DMRS port that is configured or indicated with a same index for the plurality of uplink transmissions.

11. The method of claim 3, wherein a maximum number of PTRS ports configured for the first uplink transmission is different from others of the plurality of uplink transmissions.

12. The method of claim 1, wherein the first uplink transmission is configured with a maximum number of PTRS ports, that is smaller than others of the plurality of uplink transmissions.

13. A method comprising:
sending, by a wireless communication node to a wireless communication device, a first signaling that includes a phase tracking reference signal (PTRS)-demodulation reference signal (DMRS) port association; and
causing the wireless communication device to determine that the PTRS-DMRS port association corresponds to a first uplink transmission of a plurality of uplink transmissions.

14. A wireless communication node, comprising:
at least one processor configured to:
send, via a transmitter to a wireless communication device, a first signaling that includes a phase tracking reference signal (PTRS)-demodulation reference signal (DMRS) port association; and
cause the wireless communication device to determine that the PTRS-DMRS port association corresponds to a first uplink transmission of a plurality of uplink transmissions.

15. A wireless communication device, comprising:
at least one processor configured to:
receive, via a receiver a from a wireless communication node, a first signaling that includes a phase tracking reference signal (PTRS)-demodulation reference signal (DMRS) port association; and
determine that the PTRS-DMRS port association corresponds to a first uplink transmission of a plurality of uplink transmissions.

16. The wireless communication device of claim 15,
wherein each of the plurality of uplink transmissions comprises a respective group of physical uplink shared channel (PUSCH) transmission, a group of transmissions associated with a respective sounding reference signal (SRS) resource sets, a group of transmissions to a respective transmission-reception point (TRP), a group of transmissions associated with a respective quasi-colocation (QCL) assumption, or a group of transmissions associated with one path loss reference signal (PL-RS), and
wherein each group of transmissions comprises at least one transmission.

17. The wireless communication device of claim 15, wherein the first uplink transmission is indicated with a larger number of actual PTRS ports, than others of the plurality of uplink transmissions.

18. The wireless communication device of claim 15, wherein the first uplink transmission is indicated with a smaller number of actual PTRS ports, than others of the plurality of uplink transmissions.

19. The wireless communication device of claim 15, wherein the first uplink transmission has a rank of 2.

20. The wireless communication device of claim 15, wherein the first uplink transmission is configured with a maximum number of PTRS ports, that is larger than others of the plurality of uplink transmissions.
